(19) United States
(12) Patent Application Publication
(10) Pub. No.: US 2018/0001562 A1
(43) Pub. Date: Jan. 4, 2018

(54) METHOD FOR EXPOSING A THREE-DIMENSIONAL REGION

(71) Applicant: Way to Production GmbH, Wien (AT)

(72) Inventors: Andreas FITZINGER, Wien (AT); Simon GRUBER, Wien (AT)

(21) Appl. No.: 15/545,699

(22) PCT Filed: Jan. 12, 2016
(86) PCT No.: PCT/EP2016/050409

§ 371 Date: Jul. 23, 2017

(30) Foreign Application Priority Data
Jan. 22, 2015 (AT) A50038/2015

(51) Int. Cl. B29C 64/386; B33Y 50/00; B29C 64/124; B29C 64/153; B33Y 10/00

(52) U.S. Cl. CPC B29C 64/386; B33Y 50/00; B33Y 10/00; B29C 64/153; B29C 64/124

(57) ABSTRACT

A method for illuminating a three-dimensional area (1), the three-dimensional area being divided into at least two successive layers (2), which are illuminated temporally sequentially, each layer (2) being divided into at least two illumination fields (3) with at least one first subarea (4), one second subarea (4′), if appropriate a third subarea (4″) and if appropriate further subareas, wherein adjacent illumination fields (3) overlap in individual subareas (4′, 4″) to avoid defectively illuminated regions.

The invention relates to a method for illuminating a three-dimensional area.

So-called 3D printing methods are known from the prior art for forming a dimensionally stable object by illuminating a three-dimensional area of a non-dimensionally-stable compound. In these methods, a powdered or liquid substance is selectively cured in a three-dimensional area by means of the action of light or heat radiation, in order to thereby form a solid body. The three-dimensional area is divided into at least two mutually adjacent layers for this purpose, which layers are illuminated temporally sequentially with a predetermined illumination intensity. The substance cures due to the illumination and becomes dimensionally stable, so that one layer after the other can be illuminated.

One problem in methods of this type is that the available optical illumination field is limited by the optical illumination system used and the resolution used. In order to also be able to illuminate other areas, which are larger than the optical illumination field at a given resolution, it is known to divide each individual layer into at least two illumination fields with mutually adjacent subareas. The entire layer information is created in this case by means of sequential illumination of a plurality of subareas.

One problem in these known methods for illuminating large areas is that in the edge areas, in which adjacent subareas adjoin one another, either an overlap or a gap in the illumination intensity can arise due to incorrect alignment. This is evident in these areas in too strong an illumination, which leads to over-curing, or illumination that is too weak or absent, which leads to a lack of curing. As the defective alignment additionally stays the same from layer to layer, this fault is evident in a very clearly visible seam in the object to be created, which in particular also appears as an undesired geometric inaccuracy, seam or fracture.

It is the object of the present invention to create a method in which this defective illumination (over-, under- or non-illumination) is avoided, and which makes it possible in a simple manner to illuminate three-dimensional areas which are larger than the available illumination field, wherein the formation of seams and fractures at the boundaries of the subareas should be prevented.

The object according to the invention is initially achieved in that adjacent illumination fields overlap in individual subareas. As a result, the occurrence of gaps between the illumination fields, in which no or a reduced curing takes place, is prevented. In the case of a rectangular arrangement of the sub areas for example, an overlap of two subareas occurs at the edges, and an overlap or four subareas occurs at the corners.

The shape and construction of the overlapping subareas can be arbitrary according to the invention. The overlapping subareas can in particular take on rectangular, triangular or other geometric shapes. In the case of the illumination of irregular structures in particular, the use of non-rectangular overlapping subareas can be provided according to the invention.

According to the invention, it may also be provided to permit an overlap of any desired number of subareas, in order to achieve an illumination of the entire area which is as fast as possible, wherein the illumination intensity in the overlapping subareas is adapted accordingly, in order to achieve a target value of the illumination intensity in the overlapping subareas.

According to the invention, the extent of the overlapping subareas may be dependent on the resolution used in the case of pixel-based illumination and can preferably be at least one to five pixels.

To avoid over-illumination in the overlap areas, it can be provided according to the invention that the average illumination intensity in the overlapping subareas is lower than in the non-overlapping subareas.

In the simplest case, illumination is carried out in the overlapping subareas in each case for example only with half of the illumination energy and/or half of the illumination time of the predetermined target value. In total, the target value of the illumination intensity consequently results in the overlapping subareas.

According to the invention, this can take place by means of direct control of the pixels in the overlapping subareas by means of pulse width modulation or by means of the use of a partial grey stage in the overlapping area. A plurality of overlap areas may be provided depending on the number of illumination fields and therefore a plurality of partial intensity values may be required per individual image.

Depending on the number of subareas with which the overlap is realized, the illumination intensity in these areas is reduced accordingly, in order to reach the provided target value of the illumination intensity. In particular, it may be provided that illumination is only carried out at half intensity at the edges of a subarea, and is only carried out at a quarter of the intensity of the non-overlapping area at the corners. In the case of overlapping of any desired number of subareas, the illumination intensity in these subareas can be reduced to a corresponding fraction of the illumination intensity in the non-overlapping subarea, in order, in total, to reach the target value of the illumination intensity in the overlapping subareas.

According to the invention, it can furthermore be provided that the illumination intensity in the overlapping subareas of adjacent layers is different. In particular, it can be provided that the illumination intensity in the overlapping subareas varies from layer to layer. This has the advantage that even if the resulting intensity and the precise shape of the overlap area cannot be set exactly, a seam passing through the entire object formed, which would consequently be evident as a fracture or a geometric inaccuracy, is not created.

According to the invention, it can furthermore be provided that the illumination intensity in the overlapping subareas varies in one or two location coordinates of the layer, so that the illumination intensity in these areas is dependent on location.

As a result, any desired energy curve can be realized in the overlapping subareas of the illumination field. As a result, it can be achieved in particular, that a different illumination intensity or a different curve of the illumination intensity is achieved in the interior of the object to be illuminated than at the edge of the object to be illuminated.

According to the invention, it can furthermore be provided that in individual overlapping subareas, a locally constant illumination intensity is provided, and a locally variable illumination intensity is provided in other overlapping subareas. Thus, a constant illumination intensity can for example be provided in the corners of a subarea, and an illumination intensity which varies in the x or y direction can be provided at the edges, wherein x and y label the two-dimensional location coordinates of a layer. The illumination intensity can also vary around the respective target value of the intensity in this two-dimensional area.

According to the invention, it can furthermore be provided that the illumination intensity in the overlapping subareas varies around a layer-dependent target value along successive layers at a point in the illumination field, that is to say a fixed x and y coordinate. This has the advantage according to the invention that the target value of the illumination is achieved on average, even if the illumination fields and overlap areas are not set completely exactly, so that the formation of a seam along the layers is prevented completely.

According to the invention, it can be provided that the variation around the layer-dependent target value is at least 5%, preferably at least 10% of the target value. According to the invention, it can furthermore be provided that the illumination fields are illuminated simultaneously. According to the invention, it can furthermore be provided that the illumination fields are illuminated in a temporal sequence.

According to the invention, it can furthermore be provided that a plurality of illuminations of the same or different intensity are carried out in a temporal sequence. For example, initially the entire illumination field can be carried out with a base intensity, and then selected subareas are illuminated at least once with an additional intensity.

According to the invention, it can furthermore be provided that the illumination takes place continuously, in that an illumination field is guided at a constant or variable speed over the area to be illuminated, wherein the projected illumination pattern is changed continuously. For example, the illumination pattern can be reproduced in the form of a continuous projection or a video, and the illumination field is moved at a speed which is adapted thereto.

Further features according to the invention emerge from the patent claims, the drawings and the description of the figures.

The invention is explained in more detail in the following on the basis of non-exclusive exemplary embodiments.

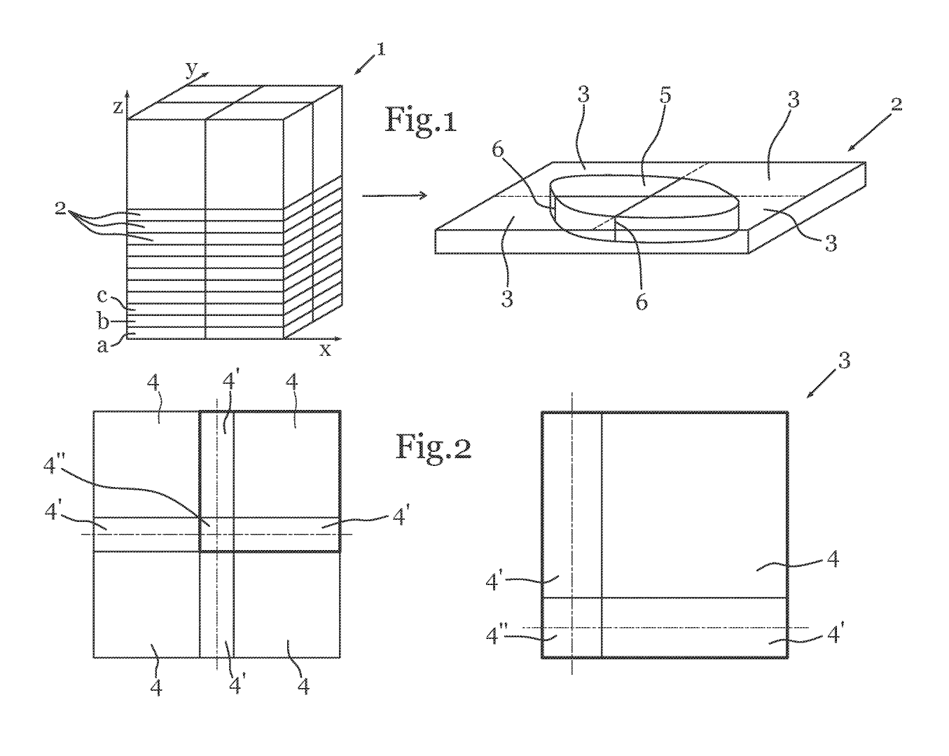

FIG. 1 shows a schematic illustration of the area to be illuminated and a detail of a layer to be illuminated;

FIG. 2 shows a schematic illustration of four overlapping illumination fields and a single illumination field with a plurality of subareas;

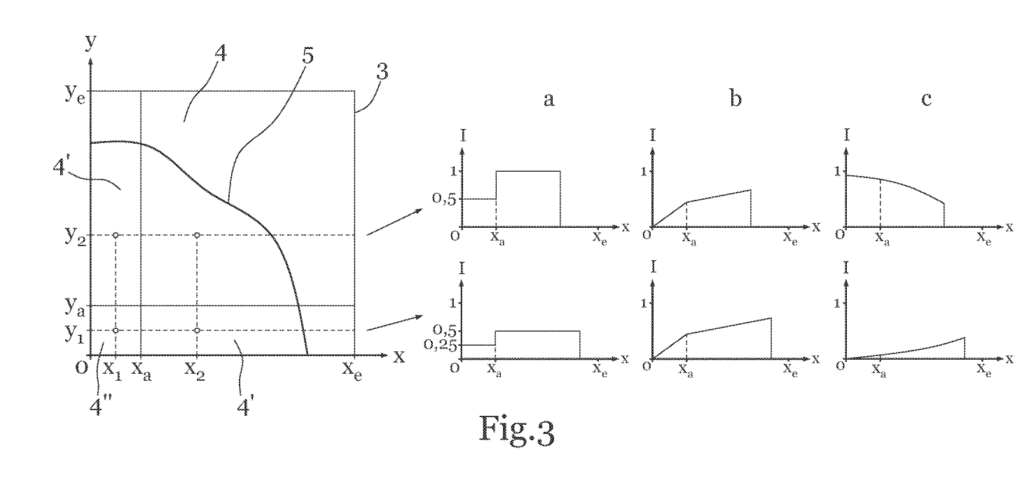

FIG. 3 shows a two-dimensional illustration of an illumination field and curves of the illumination intensity along given interfaces;

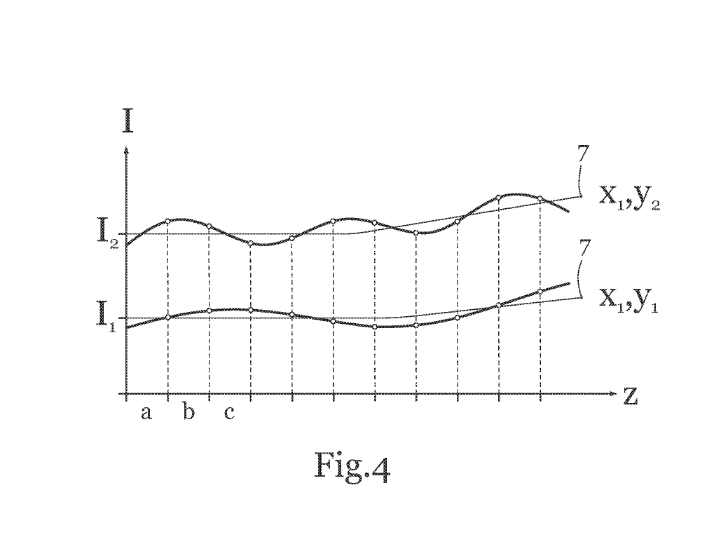

FIG. 4 shows a schematic illustration of the curve of the illumination intensity at two points in the illumination field along successive layers;

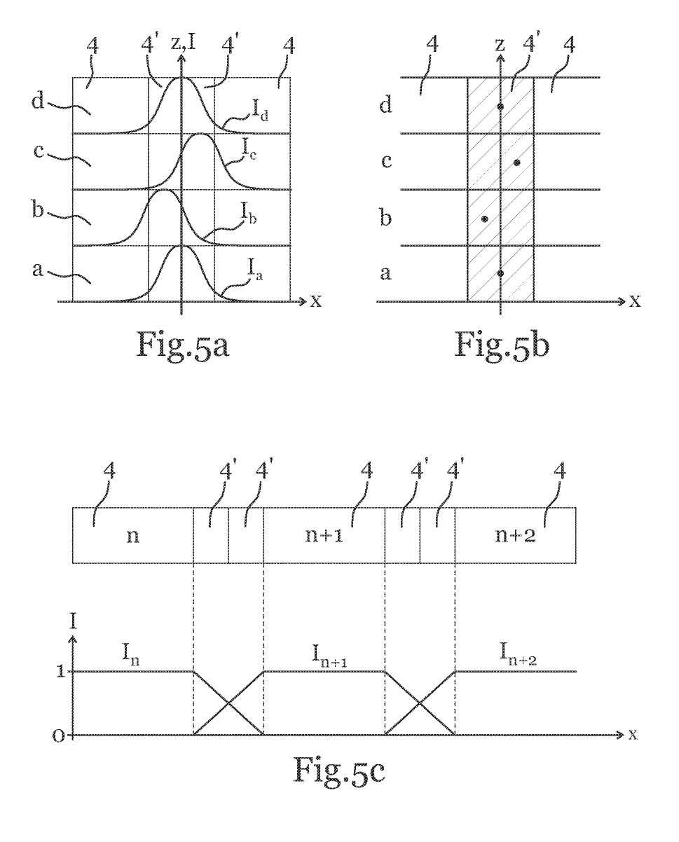

FIGS. 5a-5c show further exemplary embodiments of an embodiment according to the invention.

FIG. 1 shows a schematic illustration of the three-dimensional area 1 to be illuminated. This is divided along the z axis into successive layers 2, which are labelled with a, b, c by way of example. During illumination, the layers are processed sequentially and the object 5 to be illuminated is generated layer by layer.

A layer 2 to be illuminated is illustrated schematically in the right area of FIG. 1. The layer 2 comprises four rectangular illumination fields 3 which are arranged adjacently to one another in a rectangle and are indicated by means of broken lines. The object 5 to be developed is located in the interior of the layer 2.

The schematically illustrated seams 6, the prevention of which constitutes one of the objects of the present invention, are formed at the separation points between the individual illumination fields 3 in the case of illumination fields which are geometrically adapted to one another exactly.

FIG. 2 shows an illustration of the four illumination fields 3, which overlap in the edge regions thereof. One of the illumination fields is highlighted by way of example and illustrated in the right portion of FIG. 2. The illumination field 3 comprises first, second and third subareas 4, 4′, 4″, wherein the first subarea 4 does not overlap with other illumination fields, the second subarea 4′ overlaps with a different illumination field and the third subarea 4″ overlaps with three other illumination fields. Accordingly, the illumination intensity is different in each case in the first, second and third subareas 4, 4′, 4″.

FIG. 3 shows a schematic illustration of an illumination field 3 and the curve of the illumination intensity I along the x coordinate in the layers a, b and c at the y coordinates y1 and y2. Likewise indicated is the curve of the object 5 to be illuminated, wherein the illumination intensity generally drops to zero outside of this object 5.

The curve of the illumination intensity I in layer a is illustrated as an example. The illumination intensity along the y coordinate y1 is initially 0.25, as four illumination fields overlap in the subarea 4″. Starting from the x coordinate xa, the intensity increases to 0.5, as two illumination fields overlap in the subarea 4′. The illumination intensity along the y coordinate y2 is initially 0.5, as two illumination fields overlap in the subarea 4′. Starting from the x coordinate xa, the intensity increases to 1, as no illumination fields overlap in the subarea 4.

Further curves of the intensity I are illustrated by way of example for the layers b and c. Thus, the intensity in the x direction can increase linearly, non-linearly or in a combined manner up to the coordinate xa with a different gradient, as shown for layer b. The intensity can initially also be high and then fall in the x direction linearly, non-linearly or exponentially, as illustrated by way of example for layer c.

Also, a linear or non-linear course in the y direction can be provided according to the invention. The curves of the intensity chosen in each case depend on the respective object.

FIG. 4 by way of example shows a curve of the illumination intensity in the direction of the z coordinate along the layers 2 at the fixed positions c1, y1 (in subarea 4″) and x1, y2 (in subarea 4′) inside the overlap areas of an illumination field 3. The illumination intensity 11, 12 is chosen in such a manner that it varies around the target value required at this point in each case, so that even if the overlap of the subareas 4′, 4″ is defective, the formation of seams is prevented and the illumination intensity on average along the layers at this point is correct.

FIG. 5a shows a schematic illustration of an intensity curve according to the invention in four successive layers a, b, c and d, which in each case have two first, non-overlapping subareas 4, and a second, overlapping area 4′. The local progression of the illumination intensity in the layers a, b, c and d is labelled with Ia, Ib, Ic and Id and in each case follows a bell or Gaussian curve, wherein any desired other curves can also be provided according to the invention. In order to prevent the maxima of the intensity in each layer from being situated at the same x position, the Gaussian curve in each layer is arranged in a displaced manner with respect to the adjacent layers.

FIG. 5b shows the same layer arrangement, wherein the maximum of the intensity in each layer is indicated with a dot. As the maxima in adjacent layers always come to lie at different x positions, the formation of a rectilinear seam is prevented, so that the joining of the subareas 4 lying next to one another and the layers a, b, c, d lying above one another benefits.

FIG. 5c shows a further illustration of an intensity curve according to the invention in three subareas n, n+1 and n+2 with overlapping subareas 4′, which are arranged next to one another. in the overlapping subareas 4′, the illumination intensity of each subarea 4 is linearly reduced to zero, so that by addition of the intensity in the overlapping subareas, the target value of the illumination intensity results. According to the invention, any desired other curves of the illumination intensity can be provided.

The invention is not limited to the present exemplary embodiments, but rather comprises all methods in the scope of the patent claims which follow. Furthermore, the invention also extends to the three-dimensional objects generated by using the method.

1. A method for illuminating a three-dimensional area (1), the three-dimensional area being divided into at least two successive layers (2), which are illuminated temporally sequentially, each layer (2) being divided into at least two illumination fields (3) with at least one first subarea (4), one second subarea (4′), if appropriate a third subarea (4″) and if appropriate further subareas, wherein adjacent illumination fields (3) overlap in individual subareas (4′, 4″) to avoid defectively illuminated regions.

2. The method according to claim 1, wherein to avoid over-illumination, the average illumination intensity in the overlapping subareas (4′, 4″) is lower than in the non-overlapping subareas (4).

3. The method according to claim 2, wherein the illumination intensity in the overlapping subareas (4′, 4″) of adjacent layers (2) is different.

4. The method according to claim 3, wherein the illumination intensity in the overlapping subareas (4′, 4″) varies in one or two location coordinates, so that the illumination intensity in these areas is dependent on location.

5. The method according to claim 3, wherein in individual overlapping subareas (4′), a locally constant illumination intensity is provided, and a locally variable illumination intensity is provided in other overlapping subareas (4″).

6. The method according to claim 3, wherein the illumination intensity in the overlapping subareas (4′, 4″) varies around a layer-dependent target value along successive layers (2) at a point in the illumination field (3).

7. The method according to claim 6, wherein the variation is at least 5%, preferably at least 10% of the target value.

8. The method according to claim 6, wherein the variation in a second subarea (4′) is lower than in a third subarea (4″).

9. The method according to claim 1, wherein the illumination fields (3) are illuminated simultaneously.

10. The method according to claim 1, wherein the illumination fields are illuminated in a temporal sequence.

11. The method according to claim 1, wherein the subareas (4, 4′, 4″) have an essentially rectangular shape.

12. The method according to claim 1, wherein the subareas (4, 4′, 4″) have any desired geometric shape.

13. The method according to claim 1, wherein any desired number, preferably two or four, subareas (4′, 4″) overlap, wherein the illumination intensity is adapted accordingly in the overlapping subareas, in order to achieve a target value of the illumination intensity in the overlapping subareas.

14. The method according to claim 1, wherein a plurality of illuminations of the same or different intensity are carried out in a temporal sequence in individual or all subareas (4, 4′, 4″).

15. The method according to claim 1, wherein the illumination takes place continuously, in that an illumination field is guided at a constant or variable speed over the area to be illuminated, wherein the projected illumination pattern is adapted continuously.

16. A three-dimensional object, generated using a method for illumination according to claim 1.
